(19) United States
(12) Patent Application Publication
(10) Pub. No.: US 2016/0047316 A1
(43) Pub. Date: Feb. 18, 2016

(54) SYSTEMS AND APPARATUS RELATING TO GAS TURBINE COMBUSTORS

(71) Applicant: General Electric Company, Schenectady, NY (US)

(72) Inventors: Patrick Benedict Melton, Horse Shoe, NC (US); Vaibhav Nadkarni, Bangalore (IN); Hasan Karim, Simpsonville, SC (US); Lucas John Stoia, Taylors, SC (US)

(73) Assignee: General Electric Company

(21) Appl. No.: 14/459,392

(22) Filed: Aug. 14, 2014

(51) Int. Cl. F02C 7/22; F02C 7/12

(52) U.S. Cl. CPC F02C 7/22; F02C 7/12

(57) ABSTRACT

A gas turbine engine having a combustor that includes: an inner radial wall defining axially stacked first and second interior chambers, wherein the first interior chamber extends axially from an end cover to a fuel nozzle, and the second interior chamber extends axially from the fuel nozzle to an inlet of the turbine; and an outer radial wall formed about the inner radial wall so to form a flow annulus therebetween. The flow annulus may include a flow conditioning section that has: conditioning passages defined therethrough for directing a flow from inlets formed at an upstream end to outlets formed at a downstream end of the flow conditioning section; and structure rigidly attaching the inner radial wall to the outer radial wall.

### BACKGROUND OF THE INVENTION

This present application relates generally to the combustion systems in combustion or gas turbine engines (hereinafter “gas turbines”). More specifically, but not by way of limitation, the present application describes structural, cooling, and air flow conditioning apparatus and systems for use within flow annulus common to many types of gas turbine combustors.

The efficiency of gas turbines has improved significantly over the past several decades as new technologies enable increases to engine size and higher operating temperatures. One technical basis that allowed these higher temperatures was the introduction of new and innovative heat transfer technologies for cooling components within the hot gas path. Additionally, new materials have enabled higher temperature capabilities within the combustor.

During the same time frame, however, new standards were enacted that limit the levels at which certain pollutants may be emitted during operation. Specifically, the emission levels of NOx, CO and UHC, all of which are sensitive to the operating temperature of the engine, became more strictly regulated. Of those, the emission level of NOx is especially sensitive to increased emission levels at higher firing temperatures and, thus, became a significant limit as to further temperature increases. Because higher operating temperatures coincide with more efficient engines, this hindered advances in engine efficiency. In short, combustor operation became in certain respects a limit on gas turbine efficiency.

It will be appreciated that emission levels are impacted by the manner in which compressed air and fuel are brought together for combustion. More specifically, emission levels may be reduced by conditioning the flow of compressed air so that it has uniform characteristics upon introduction to the fuel for combustion. Flows of compressed air that are not uniform result in uneven combustion, which typically increases levels of unwanted emissions. Additionally, components within the combustor, particularly the cap assembly (as discussed below), are subject to extreme mechanical and thermal loads during operation. As a result, an important design consideration remains finding cost-effective structures that also provide the necessary durability. This is particularly true of the region toward the aft end of the cap assembly because of the manner in which the cap assembly extends in cantilevered fashion from the end cover of the head end of the combustor. Further, within this region, there is a need for delivering flows of compressed air as coolant to certain components because of the proximity to the extreme thermal loads of the combustion zone. As a result, there is a continuing need for efficient, low-cost combustor apparatus and systems that enable the conditioning of the flow of compressed air before mixing it with fuel for combustion, while also providing a sturdy and reinforcing structure. The value of such designs may be further enhanced to the extent that they also provide efficient ways of delivering coolant to combustor components located near the combustion zone.

### BRIEF DESCRIPTION OF THE INVENTION

The present application thus describes a gas turbine engine having a combustor that includes: an inner radial wall defining axially stacked first and second interior chambers, wherein the first interior chamber extends axially from an end cover to a fuel nozzle, and the second interior chamber extends axially from the fuel nozzle to an inlet of the turbine; and an outer radial wall formed about the inner radial wall so to form a flow annulus therebetween. The flow annulus includes a flow conditioning section that has conditioning passages defined therethrough for directing a flow from inlets formed at an upstream end to outlets formed at a downstream end of the flow conditioning section as well as structure rigidly attaching the inner radial wall to the outer radial wall.

These and other features of the present application will become more apparent upon review of the following detailed description of the preferred embodiments when taken in conjunction with the drawings and the appended claims.

### BRIEF DESCRIPTION OF THE DRAWINGS

The invention of the present application will be more completely understood and appreciated by careful study of the following more detailed description of exemplary embodiments taken in conjunction with the accompanying drawings, in which:

FIG. 1 is a sectional schematic representation of an exemplary gas turbine in which certain embodiments of the present application may be used;

FIG. 2 is an axial cross-sectional view of a combustor in which certain embodiments of the present application may be used;

FIGS. 3 is an axial cross-sectional view of the forward half of a combustor in which certain embodiments of the present application may be used;

FIG. 4 is a perspective view of a cap assembly of a combustor in accordance with embodiments of the present invention;

FIG. 5 is a cross-sectional perspective view of the cap assembly of FIG. 4;

FIG. 6 is a cross-sectional perspective view of the cap assembly of FIG. 4;

FIG. 7 is a top view of the cap assembly of FIG. 4;

FIG. 8 is a side view of an alternative conditioning section within a flow annulus according to another exemplary embodiment of the present invention;

FIG. 9 is a sectional view along line 9-9 of FIG. 8;

FIG. 10 is a side view of an alternative conditioning section within a flow annulus according to another exemplary embodiment of the present invention; and

FIG. 11 is a sectional view along line 11-11 of FIG. 10.

### DETAILED DESCRIPTION OF THE INVENTION

In the following text, certain terms have been selected to describe the present invention. To the extent possible, these terms have been chosen based on the terminology common to the field. Still, it will be appreciate that such terms often are subject to differing interpretations. For example, what may be referred to herein as a single component, may be referenced elsewhere as consisting of multiple components, or, what may be referenced herein as including multiple components, may be referred to elsewhere as being a single component. In understanding the scope of the present invention, attention should not only be paid to the particular terminology used, but also to the accompanying description and context, as well as the structure, configuration, function, and/or usage of the component being referenced and described, including the manner in which the term relates to the several figures, as well as, of course, the precise usage of the terminology in the appended claims.

Because several descriptive terms are regularly used in describing the components and systems within turbine engines, it should prove beneficial to define these terms at the onset of this section. Accordingly, these terms and their definitions, unless specifically stated otherwise, are as follows. The terms “forward” and “aft”, without further specificity, refer to directions relative to the orientation of the gas turbine. That is, “forward” refers to the forward or compressor end of the engine, and “aft” refers to the aft or turbine end of the engine. It will be appreciated that each of these terms may be used to indicate movement or relative position within the engine. The terms “downstream” and “upstream” are used to indicate position within a specified conduit relative to the general direction of flow moving through it. (It will be appreciated that these terms reference a direction relative to an expected flow during normal operation, which should be plainly apparent to anyone of ordinary skill in the art.) The term “downstream” refers to the direction in which the fluid is flowing through the specified conduit, while “upstream” refers to the direction opposite that.

Thus, for example, the primary flow of working fluid through a turbine engine, which consists of air through the compressor and then becoming combustion gases within the combustor and beyond, may be described as beginning at an upstream location at an upstream end of the compressor and terminating at an downstream location at a downstream end of the turbine. In regard to describing the direction of flow within a common type of combustor, as discussed in more detail below, it will be appreciated that compressor discharge air typically enters the combustor through impingement ports that are concentrated toward the aft end of the combustor (relative to the combustors longitudinal axis and the aforementioned compressor/turbine positioning defining forward/aft distinctions). Once in the combustor, the compressed air is guided by a flow annulus formed about an interior chamber toward the forward end of the combustor, where the air flow enters the interior chamber and, reversing it direction of flow, travels toward the aft end of the combustor. Coolant flows through cooling passages may be treated in the same manner.

Given the configuration of compressor and turbine about a central common axis as well as the cylindrical configuration common to many combustor types, terms describing position relative to an axis will be used. In this regard, it will be appreciated that the term “radial” refers to movement or position perpendicular to an axis. Related to this, it may be required to describe relative distance from the central axis. In this case, if a first component resides closer to the central axis than a second component, it will be described as being either “radially inward” or “inboard” of the second component. If, on the other hand, the first component resides further from the central axis than the second component, it will be described herein as being either “radially outward” or “outboard” of the second component. Additionally, it will be appreciated that the term “axial” refers to movement or position parallel to an axis. Finally, the term “circumferential” refers to movement or position around an axis. As mentioned, while these terms may be applied in relation to the common central axis that extends through the compressor and turbine sections of the engine, these terms also may be used in relation to other components or sub-systems of the engine. For example, in the case of a cylindrically shaped combustor, which is common to many machines, the axis which gives these terms relative meaning is the longitudinal central axis that extends through the center of the cross-sectional shape, which is initially cylindrical, but transitions to a more annular profile as it nears the turbine.

The following description provides examples of both conventional technology and the present invention, as well as, in the case of the present invention, several exemplary implementations and explanatory embodiments. However, it will be appreciated that the following examples are not intended to be exhaustive as to all possible applications the invention. Further, while the following examples are presented in relation to a certain type of turbine engine, the technology of the present invention also may be applicable to other types of turbine engines as would the understood by a person of ordinary skill in the relevant technological arts.

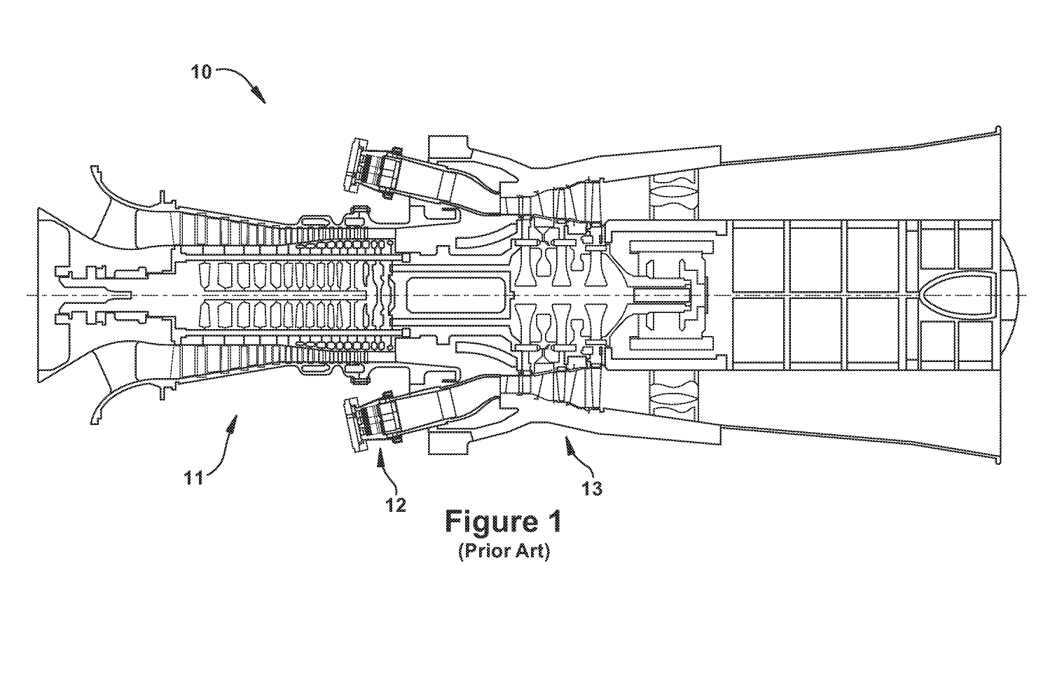

FIG. 1 is a cross-sectional view of a known gas turbine engine 10 in which embodiments of the present invention may be used. As shown, the gas turbine engine 10 generally includes a compressor 11, one or more combustors 12, and a turbine 13. It will be appreciated that a flowpath is defined through the gas turbine 10. During normal operation, air may enter the gas turbine 10 through an intake section, and then fed to the compressor 11. The multiple, axially-stacked stages of rotating blades within the compressor 11 compress the air flow so that a supply of compressed air is produced. The compressed air then enters the combustor 12 and directed through a nozzle, within which it is mixed with a supply of fuel so to form an air-fuel mixture. The air-fuel mixture is combusted within a combustion zone portion of the combustor so that a high-energy flow of hot gases is created. This energetic flow of hot gases then becomes the working fluid that is expanded through the turbine 13, which extracts energy from it.

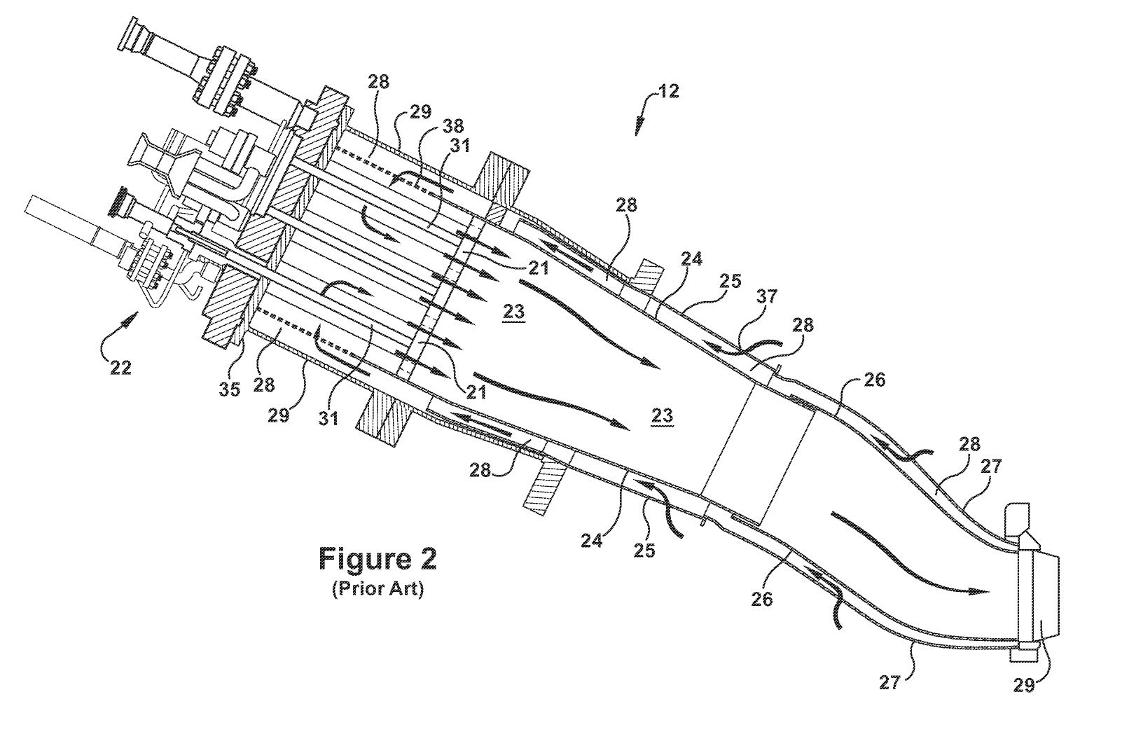

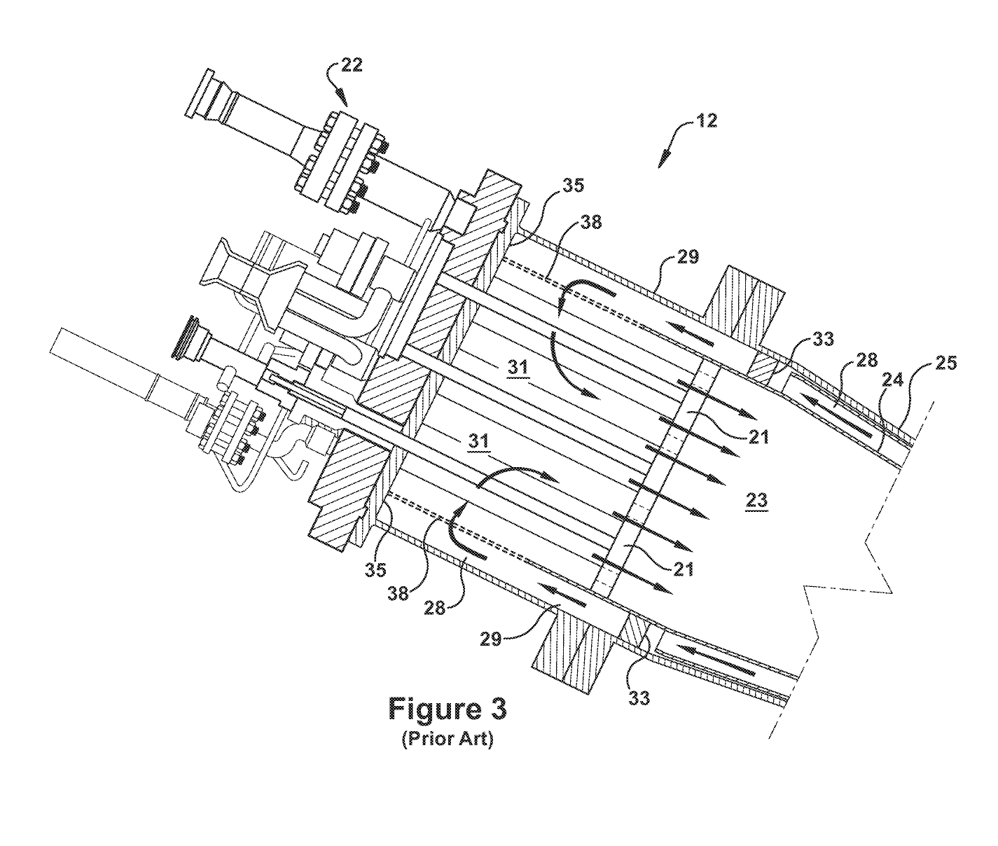

FIGS. 2 and 3 illustrate an exemplary combustor 12 in which embodiments of the present invention may be used. The forward end the combustor 12 includes a head end 22, which generally provides the various manifolds and apparatus that supply the necessary fuel to the fuel nozzle 21. The head end 22 may include an end cover 35 that defines a forward boundary of the interior chambers of the combustor 12. The interior chambers may include a chamber positioned within a cap assembly 31, a combustion zone 23, which is defined by a liner 24, and a transition zone, which is the downstream extension of the combustion zone that is defined by a transition piece 26. As illustrated, a plurality of fuel lines may extend through the end cover 35 to the fuel nozzle 21, which is positioned at the aft end of the cap assembly 31. The forward portion of the combustor 12 may be enclosed within a combustor casing 29.

As will be appreciated the fuel nozzle 21 represents the main delivery and injection point of fuel within the combustor 12. It will be appreciated that the cap assembly 31 generally is cylindrical in shape and positioned immediately aft of the head end 22 and, generally, toward the forward end to the combustor 12. The cap assembly 31 may be surrounded by the combustor casing 29. It will be appreciated that the cap assembly 31 and the casing 29 may each have a cylindrical configuration and be arranged concentrically. In this arrangement, the cap assembly 31 may be described as an inner radial wall, and, positioned about the cap assembly 31, the casing 29 may be described as an outer radial wall. In this manner, the combustor casing 29 and the cap assembly 31 form an annulus between them, which is referred to herein as a combustor casing annulus or, more generally, as flow annulus 28. The cap assembly 31 also may include one or more inlets 38 that allow fluid communication between the flow annulus 28 and the interior of the cap assembly 31.

The fuel nozzle 21 may include a planar array of injectors. As illustrated, the fuel nozzle 21 typically is positioned at the aft end of the cap assembly 31. It will be appreciated that the combustion zone 23 occurs immediately aft of the fuel nozzle 21 and is defined by the surrounding liner 24. In operation, the combustor is configured so that fuel nozzle 21 brings together for combustion the fuel supplied via the conduit extending through the head end 22 and the air supplied via the flow annulus 28. The fuel, for example, may be natural gas. The compressed air, as indicated in FIG. 2 by the several arrows, may enter the combustor 12 via ports formed along its exterior.

As mentioned, the combustion zone 23 is defined by a surrounding liner 24. Positioned about the liner 24 is a flow sleeve 25. The flow sleeve 25 and the liner 24 also may be arranged in a concentric cylindrical configuration and, thereby, provide a continuation of the flow annulus 28 formed between the cap assembly 31 and the combustor casing 29. A transition piece 26 may connect to the liner 24 and transition the flow of combustion products aftward toward input into the turbine 13. It will be appreciated that the transition piece 26 generally transitions the flow from the circular cross-section of the liner 24 to the annular cross-section necessary for input into the turbine 13. An impingement sleeve 27 may surround the transition piece 26 so that the flow annulus 28 extends further aftward. At the downstream end of the transition piece 26, an aft frame 29 directs the flow of the combustion products toward the airfoils of the turbine 13.

The flow sleeve 25 and the impingement sleeve 27 typically have impingement apertures or ports 37 formed therethrough which allow an impinged flow of compressed air to enter the flow annulus 28. This impinged flow serves to convectively cool the exterior surfaces of the liner 24 and the transition piece 26. The compressed air then is directed via the flow annulus 28 toward the forward end of the combustor 12. Then, via the inlets 38 in the cap assembly 31, the compressed air is directed into the interior of the cap assembly 31 and is redirected via the end cover 35 toward the fuel nozzle 21. It will be appreciated that the transition piece 26/impingement sleeve 27, the liner 24/flow sleeve 25, and the cap assembly 31/combustor casing 29 pairings extend the flow annulus 28 almost the entire length of the combustor 12. As used herein, the term “flow annulus” may be used generally to refer to this entire annulus or a portion thereof. Upon entering the cap assembly 31, the flow of compressed air is redirected an approximate 180° so to deliver it to the fuel nozzle 21. As used herein, the cap assembly 31 and the combustion chamber 23 defined by the liner 24 may be referred to, respectively, as an axially stacked first interior chamber and a second interior chamber. Additionally, as previously stated, the concentrically arranged cylindrical walls which form the flow annulus 28 may be referred to herein as having an “inner radial wall” and an “outer radial wall”. It will be appreciated that this arrangement is often referred to as a can combustor. As indicated in FIG. 3, a plurality of vanes 33 may be provided within the flow annulus 28. The vanes 33 may take a variety of shapes. Typically, the vanes 33 have an airfoil shape or at least a thin profile, and each may extend between a connection formed with the inner radial wall and a connection formed with the outer radial wall. In this manner, the vanes 33 provide structural support to the cap assembly 31. The vanes 33 may be circumferentially spaced about the circumference of the cap assembly 31.

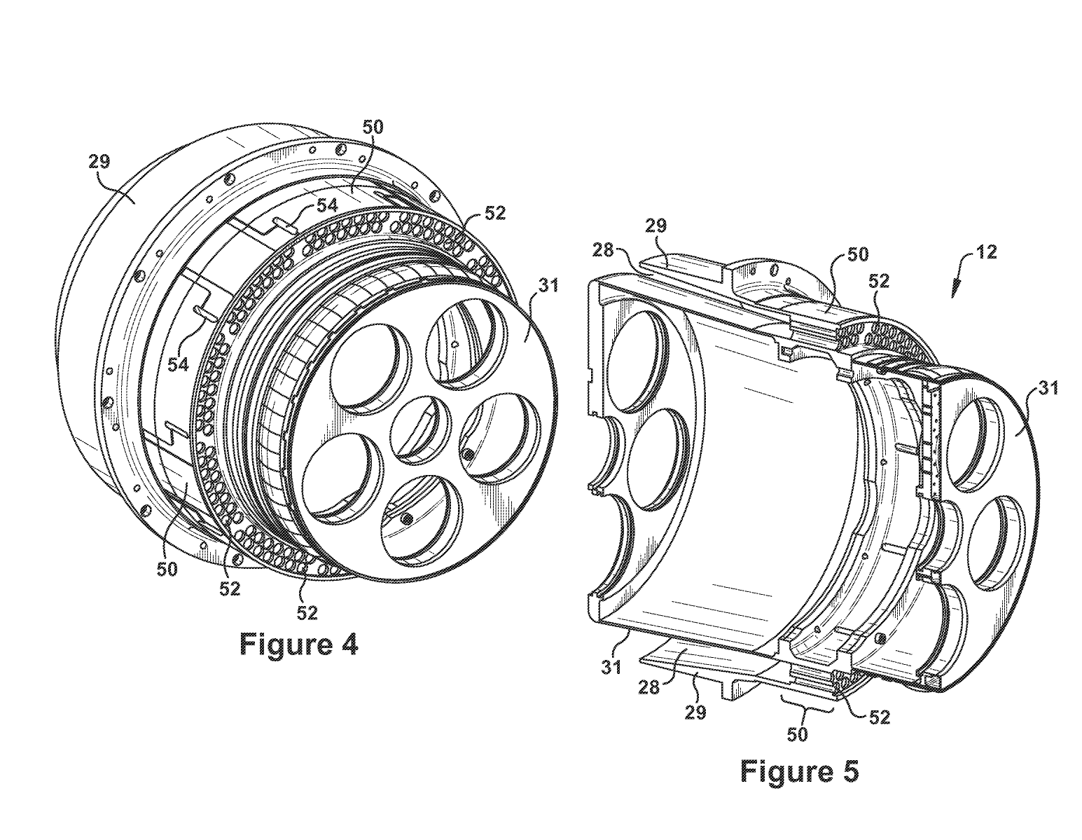

FIGS. 4 through 7 provide different perspectives of a cap assembly 31 and surrounding components of a combustor in accordance with a preferred embodiment of the present invention. According the present invention, a flow conditioning section 50 may be included within the flow annulus 28. According to certain preferred embodiments, the flow conditioning section 50 may include a number of conditioning passages 52 defined across a wide axial section of the flow annulus 28. In the illustrated embodiments of FIGS. 4 through 7, the flow conditioning section 50 is shown having a relatively wide axial thickness so that the conditioning passages 52 become elongated tubes that stretch between inlets formed on the upstream side of the flow conditioning section 50 and outlets formed on a downstream side of it. Though other shapes are also possible, the conditioning passages 52 may have a cylindrical shape. The conditioning passages 52 may be parallel to each other, as well as being parallel to a center axis of the combustor. As illustrated, the upstream side of the flow conditioning section 50 may include a planar surface that is arranged approximately perpendicular to the flow direction through the flow annulus 28. The inlets of the conditioning passages 52 may be formed through the upstream side. The downstream end of the flow conditioning section 50 also may include a planar surface approximately perpendicular to the flow direction through flow annulus. The outlets of the conditioning passages 52 may be formed through this downstream side. The number of conditioning passages 52 included within the flow conditioning section 50 may vary depending on application. In an exemplary embodiment, the number of conditioning passages 52 may be between 100 and 200.

The conditioning passages 52 may be configured within the flow conditioning section 50 so that circumferentially arranged rows are formed. As illustrated, the rows may include an inner radial row and an outer radial row, with the inner radial row residing closer to the center axis of the combustor. As also illustrated, the conditioning passages 52 of the inner radial row and the outer radial row may be configured so to include an angular offset. As more clearly shown in FIG. 7, the angular offset may include an alternating arrangement in which the angular placement of one of the conditioning passages 52 of the inner radial row alternates with the angular placement of one of the conditioning passages 52 of the outer radial row. In the case where the conditioning passages 52 are positioned so to form an inner radial row and an outer radial row in radial row, each row may include between 50 and 100 conditioning passages 52, though other configurations are also possible.

In accordance with the present invention, the flow conditioning section 50 includes an internal structure that rigidly connects the walls that it extends between. More specifically, in combustors having concentrically formed inner and outer radial walls, the flow conditioning section 50 may condition the flow of compressed air moving through the flow annulus 28 while also providing enhanced structural support between the walls that it connects. Additionally, the structure may be configured so that each of the conditioning passages 52 is a discrete passage, which, as used herein, means that each conditioning passage 52 does not fluidly communicate with any of the other conditioning passages 52, i.e., is separated from the other conditioning passages 52 by the structure of the flow conditioning section 50. That is, pursuant to certain embodiments, the internal structure of the flow conditioning section 50 is configured so to define continuous but separated passageways that extend from the upstream face to the downstream face of the flow conditioning section 50. According to certain preferred embodiments, the circumferential offset and the alternating arrangement described above regarding inner and outer radial rows of conditioning passages may be configured so to create a cross-sectional web pattern within the structure of the flow conditioning section 50. It will be appreciated that this type of structural configuration is one that may provide a robust and durable structure while still allowing the dedication of a large cross-sectional area for the conditioning passages 52. This is an important consideration because, while structural integrity is significant given the mechanical and thermal loads within the region, the flow area of the conditioning passages 52 as to the large enough to the high level of air flow passing through the combustor. The flow conditioning section 50 may rigidly attached to both the inner radial wall, which for example may be the cap assembly 31, and the outer radial wall, which for example may be the combustor casing 29. As discussed more below, according to certain preferred embodiments, the flow conditioning section 50 may be formed as an integral component to the outer radial wall, the inner radial wall, or both the outer radial and inner radial walls.

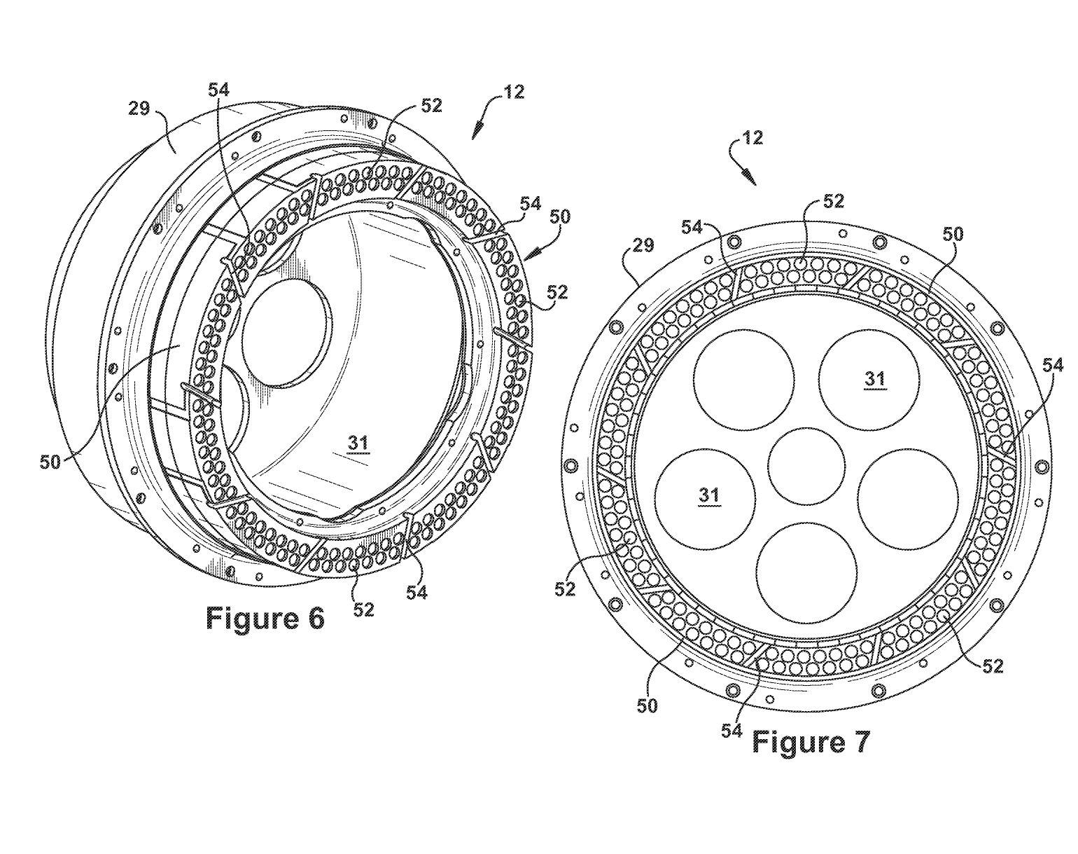

According to another aspect of the present invention, as illustrated most clearly in FIG. 6, the flow conditioning section 50 may include coolant passages 54 that extend radially or approximately radially between the connections it makes with the outer and inner radial walls. More specifically, each of the coolant passages 54 may extend between an inlet formed at the outer radial wall to an outlet formed at the inner radial wall, wherein the inlet connects to a supply feed while the outlet provides a supply of coolant to a passage within the cap assembly that is connected thereto. The number of coolant passages 54 may vary depending on application. According to certain preferred embodiments, the flow conditioning section 50 may include between 10 and 20 of the coolant passages that are circumferentially spaced about the flow conditioning section 50. The internal structure of the flow conditioning section 50 may be configured so to separate each of the coolant passages 54 from each of the conditioning passages 52. The inlets of the coolant passages 54 may connect to a supply feed that fluidly communicates with a region exterior to the combustor. The region exterior to the combustor may be one into which discharge from the compressor is supplied during operation. Each of the outlets of the coolant passages 54 may connect to a passage formed within the inner radial wall, and that passage may be configured to provide cooling to a portion of the cap assembly 31 or some other combustor component. As illustrated in FIG. 6, the coolant passages 54 may be canted relative to the radial direction of the combustor. According to preferred embodiments, this canted configuration may corresponds to the circumferential offset between the inner radial row and the outer radial row of the conditioning passages 52, as illustrated in FIG. 6.

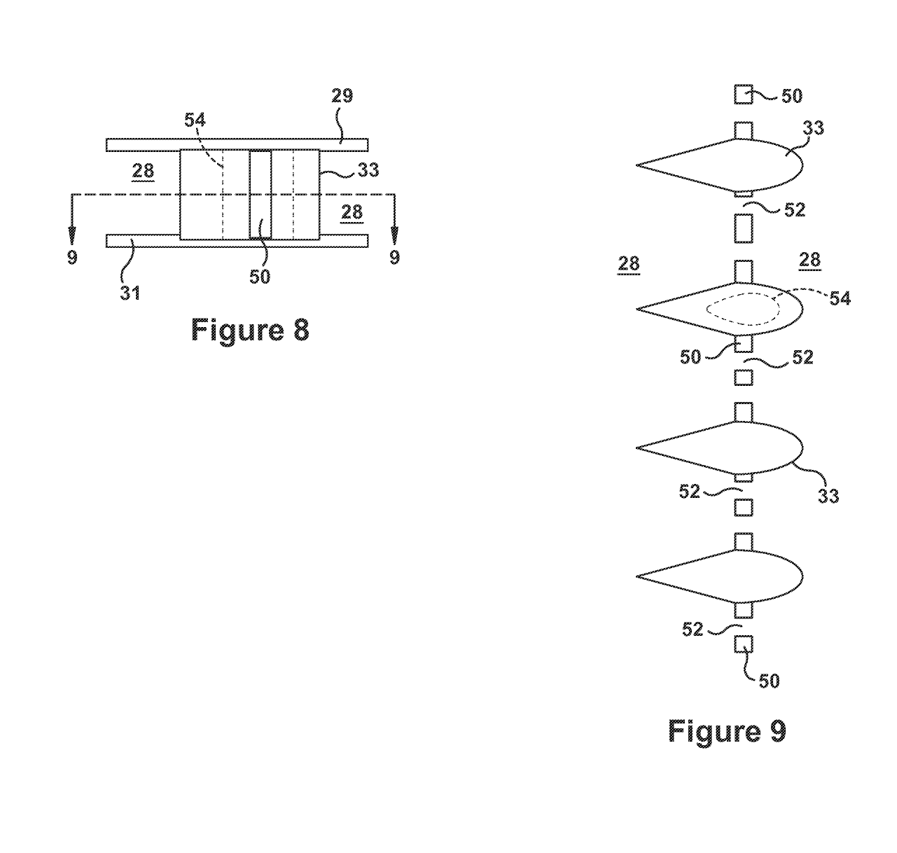

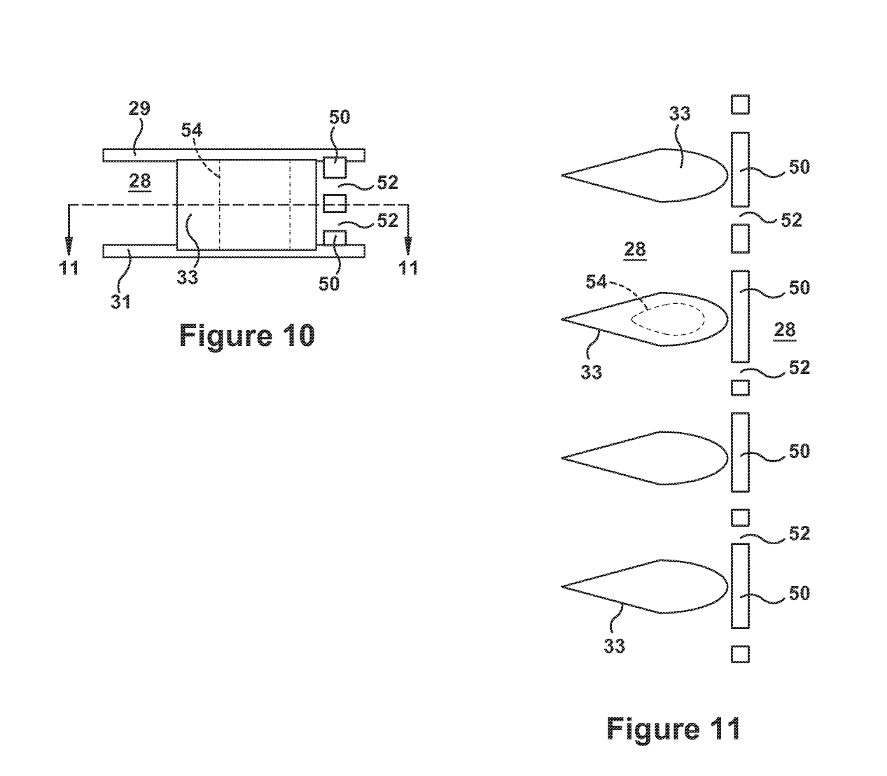

In other embodiments, as illustrated in FIGS. 8 through 11, the flow conditioning section 50 may have a narrower axial thickness. In this case, the flow conditioning section 50 may be configured as a perforated plate. It will be appreciated that, in this example, the perforations formed the conditioning passages 52. As stated, a combustor may include a plurality of vanes 33 within the flow annulus 28. As illustrated in FIGS. 8 and 9, in accordance with embodiments of the present invention, the flow conditioning section 50 may intersect the vanes 33 as it extends around the flow annulus 28. The flow conditioning section 50 may be integrally formed with the vanes 33, or, in other embodiments, the flow conditioning section 50 may be a separately fabricated component that is later attached to the vanes 33 during a manufacturing or retrofit process. According to alternative embodiments, as shown in FIGS. 10 and 11, the narrower flow conditioning section 50 also may be positioned just upstream of the vanes 33. It will be appreciated that according to another embodiments, the narrower flow conditioning section 50 also may be positioned just downstream of the vanes 33. As illustrated in FIGS. 9 and 11, in such instances, cooling passages 54 may be included within one or more of the vanes 33.

The axial positioning of the flow conditioning section 50 within the flow annulus 28 may vary according to different applications. According to certain preferred embodiments, the flow conditioning section 50 is axial positioned in the flow annulus 28 so to correspond with an axial position of the aft portion of the cap assembly 31. Alternatively, the positioning of the flow conditioning section 50 may be defined within an axial range. Preferably, the axial range within which the flow conditioning section 50 is located is defined at a first end by the end cover and at a second end by an axial position coinciding with the aft and or termination point of the cap assembly 31.

In operation, the flow conditioning section 50 may positioned within annulus 28 of the combustor so to condition uneven flow characteristics or distribution and thereby make the flow more uniform before entering the cap assembly 31. The cap assembly 31 may include fuel nozzles or injectors, which according to certain embodiments are configured as swozzles or micromixer tubes. It will be appreciated that the flow conditioning section 50, thus positioned, introduces a pressure drop in the flow annulus that feeds downstream fuel nozzles and makes the air profile more uniform. According to prior art designs, such uniformity is often compromised from preferential cooling through the impingement sleeve and obstructions in the annulus, such as by vanes, that are typically positioned therein, as well as other factors. The flow conditioning section 50 further provides robust and efficient structural support between the cap assembly 31 and the surrounding wall, for example, the combustor casing 29, which together for the annulus 28. Once through the flow conditioning section 50, the condition supply of compressed air continues toward the end cover of the head end where it is redirected toward the fuel nozzles positioned at the aft end of the cap assembly 31. In this manner and as further described above, the flow conditioning section 50 provides an efficient, cost-effective and robust design for conditioning the supply of compressed air just before being introduced to the fuel and combusted therewith, which may beneficially impact emission levels, such as NOx.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, all of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A gas turbine engine having a compressor, a combustor, and a turbine, wherein the combustor includes:
an inner radial wall defining axially stacked first and second interior chambers, wherein the first interior chamber extends axially from an end cover to a fuel nozzle, and the second interior chamber extends axially from the fuel nozzle to an inlet of the turbine; and
an outer radial wall formed about the inner radial wall so to form a flow annulus therebetween;
wherein the flow annulus includes a flow conditioning section that includes:
conditioning passages defined therethrough for directing a flow from inlets formed at an upstream end to outlets formed at a downstream end of the flow conditioning section; and
structure rigidly attaching the inner radial wall to the outer radial wall.

2. The gas turbine engine according to claim 1, wherein the structure of the flow conditioning section comprises an integrally formed component relative the inner radial wall and the outer radial wall.

3. The gas turbine according to claim 1, wherein each of the conditioning passages comprise a cylindrical shape and an orientation parallel to a center axis of the first interior chamber; and
wherein the upstream end of the flow conditioning section comprises a planar surface approximately perpendicular to the flow annulus, and the downstream end of the flow conditioning section comprises a planar surface approximately perpendicular to the flow annulus.

4. The gas turbine according to claim 1, wherein the structure of the flow conditioning section comprises separating structure separating each of the conditioning passages from each of the other conditioning passages; and
wherein the flow conditioning section comprises between 100 and 200 conditioning passages.

5. The gas turbine according to claim 1, wherein the conditioning passages are positioned so to comprise circumferentially arranged rows in which an inner radial row resides inboard of an outer radial row.

6. The gas turbine according to claim 5, wherein the conditioning passages of the inner radial row comprise an angular offset relative the conditioning passages of the outer radial row.

7. The gas turbine according to claim 6, wherein the angular offset comprises an alternating arrangement in which angular placements of the conditioning passages of the inner radial row and the outer radial row alternate.

8. The gas turbine according to claim 7, wherein the angular offset and the alternating arrangement of the inner radial row and the outer radial row of the flow conditioning passage is configured so to form a web pattern through a cross-section of the structure of the flow conditioning section; and
wherein each of the inner radial row and the outer radial row comprises between 50 and 100 conditioning passages.

9. The gas turbine engine according to claim 1, wherein the flow conditioning section includes a wide axial thickness so that the conditioning passages comprise elongated tubes.

10. The gas turbine engine according to claim 1, wherein the flow conditioning section comprises a narrow axial thickness configured so to form a perforated plate, wherein the conditioning passages comprise the perforations formed therethrough.

11. The gas turbine engine according to claim 10, further comprising a plurality of vanes spaced circumferentially about the flow annulus, each of the vanes extending between connections made at the inner radial and the outer radial walls; and
wherein the perforated plate is axially disposed just upstream of the plurality of vanes.

12. The gas turbine engine according to claim 10, further comprising a plurality of vanes spaced circumferentially about the flow annulus, each of the vanes extending between connections made at the inner radial and the outer radial walls; and
wherein the perforated plate is axially disposed just downstream of the plurality of vanes.

13. The gas turbine engine according to claim 10, further comprising a plurality of vanes spaced circumferentially about the flow annulus, each of the vanes extending between connections made at the inner radial and the outer radial walls;
wherein the perforated plate is axially disposed so to intercept an axial range of the plurality of vanes; and
wherein the plurality of vanes and the perforated plate comprise an integrally formed component.

14. The gas turbine engine according to claim 1, wherein the inner radial wall formed about the first interior chamber comprises a cap assembly and the inner radial wall formed about the second interior chamber comprises a liner; and
wherein the outer radial wall formed about the cap assembly comprises a casing and the outer radial wall formed about the liner comprises a flow sleeve, and wherein the flow sleeve comprising a plurality of impingement ports through which a region exterior to the outer radial wall fluidly communicates with the flow annulus.

15. The gas turbine engine according to claim 14, wherein the combustor comprises a can combustor;
wherein the inner radial wall and the outer radial wall comprise an approximate concentric cylindrical configuration; and
wherein the casing, the cap assembly, and the flow conditioning section comprise integrally formed components.

16. The gas turbine engine according to claim 14, wherein the flow conditioning section is axial positioned in the flow annulus so to correspond with an axial position of an aft portion of the cap assembly; and
wherein the cap assembly and the flow conditioning section comprise integrally formed components.

17. The gas turbine engine according to claim 1, wherein the flow conditioning section includes coolant passages extending between an inlet formed at the outer radial wall to an outlet formed at the inner radial wall.

18. The gas turbine engine according to claim 17, wherein the flow conditioning section comprises between 10 and 20 of the coolant passages that are circumferentially spaced about the flow conditioning section; and
wherein the structure of the flow conditioning section is configured so to separate each of the coolant passages from each of the conditioning passages.

19. The gas turbine engine according to claim 17, wherein each of the inlets of the coolant passages connects to a feed that fluidly communicates with a region exterior to the combustor into which discharge from the compressor is supplied during operation; and
wherein each of the outlets of the coolant passages connects to a passage formed through the inner radial wall configured to cool a combustor component.

20. The gas turbine according to claim 19, wherein the conditioning passages are positioned so to comprise circumferentially arranged rows in which an inner radial row resides inboard of an outer radial row, and wherein the conditioning passages of the inner radial row comprise an angular offset relative the conditioning passages of the outer radial row; and
wherein the inlet and the outlet of each of the coolant passages comprises a canted configuration that corresponds to the circumferential offset between the inner radial row and the outer radial row of the conditioning passages.
